(19) United States
(12) Patent Application Publication
(10) Pub. No.: US 2012/0078780 A1
(43) Pub. Date: Mar. 29, 2012

(54) TRANSACTIONAL SAVINGS AND INVESTMENTS

(75) Inventors: Erik S. Ross, Charlotte, NC (US); Alexander Azariy Shenkar, Roswell, GA (US); Yolandis Speed, Charlotte, NC (US); Darren Paul Stillwell, Fort Mill, SC (US); Mei-Ling In Johnson, Elsmere, DE (US); Susan S. Thomas, Gastonia, NC (US)

(73) Assignee: BANK OF AMERICA CORPORATION, Charlotte, NC (US)

(21) Appl. No.: 12/892,882

(22) Filed: Sep. 28, 2010

(51) Int. Cl. G06Q 40/00

(52) U.S. Cl. 705/39

(57) ABSTRACT

A method of transactional savings is described. First and second portions of a total amount associated with a transaction may be identified. The first portion and the second portion may be different monetary funds of the total amount of monetary funds. A first account of a customer associated with an entity may be determined, and an amount of debt of monetary funds of the first account may be determined. The first portion of the total amount of monetary funds may be applied against the amount of debt of the first account, and the second portion may be maintained in a second account of the customer. Occurrence data representative of an occurrence of a triggering event associated with a transactional savings program of the entity may be received, and an amount of the second account to permit access to by the customer may be determined based upon the occurrence data.

### BACKGROUND

Customer retention is an ideal goal of most businesses. In addition, attracting new customers is a constant mission of most businesses. As part of the process for meeting those goals, businesses develop new products and services. In certain industries, such as the financial services industry, development and implementation of new products and services for customers and potential customers is an ongoing process. Certain industries lend themselves to customers being drawn to outside factors, such as the environment, the economy, and/or the personal matters in making decisions about where to do their business.

Customers of a business may be forced to change spending habits in response to a sudden event, such as a loss of a job of the customer. If a customer has a credit card account with a business and the customer has outstanding debt on the account, the customer may not be able to make the usual monthly payments, or even the minimum payment due. This may continue until the customer is able to find new employment. Under such circumstances, a customer and a business may be faced with problems associated with an inability of the customer to make monthly payments. Although a customer may want to make payments, escalating amounts of interest fees may leave a customer with little to no options and possibly even defaulting on the loan associated with the credit card account.

Therefore, there exists a need in the art for new customer incentive products and packages that assist businesses in maintaining existing customers and growing a base of new customers.

### SUMMARY

In light of the foregoing background, the following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

Aspects of the present disclosure are directed to a method and system for transactional savings. First and second portions of a total amount associated with a transaction may be identified. The first portion and the second portion may be different monetary funds of the total amount of monetary funds. A first account of a customer associated with an entity may be determined, and an amount of debt of monetary funds of the first account may be determined. The first portion of the total amount of monetary funds may be applied against the amount of debt of the first account, and the second portion may be maintained in a second account of the customer. Occurrence data representative of an occurrence of a triggering event associated with a transactional savings program of the entity may be received, and an amount of the second account to permit access to by the customer may be determined based upon the occurrence data.

Another aspect of the present disclosure is directed to maintaining event data representative of a plurality of triggering events associated with a transactional savings program of an entity. For each triggering event, data representative of the amount of a second account to permit access to by a customer may be maintained. The amount of the second account to permit access to by the customer may be the total amount in the second account. The triggering event may be involuntary unemployment of the customer.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

A more complete understanding of aspects of the present disclosure and the advantages thereof may be acquired by referring to the following description in consideration of the accompanying drawings, in which like reference numbers indicate like features, and wherein:

FIG. 1 illustrates a schematic diagram of a general-purpose digital computing environment in which certain aspects of the present disclosure may be implemented;

FIG. 2 is an illustrative block diagram of workstations and servers that may be used to implement the processes and functions of certain embodiments of the present disclosure;

FIG. 3 is an example flow chart of an illustrative method for transactional savings in accordance with at least one aspect of the present disclosure; and

FIG. 4 is an example flow chart of an illustrative method for handling a benefit request in accordance with at least one aspect of the present disclosure.

### DETAILED DESCRIPTION

In the following description of the various embodiments, reference is made to the accompanying drawings, which form a part hereof, and in which is shown by way of illustration, various embodiments in which the disclosure may be practiced. It is to be understood that other embodiments may be utilized and structural and functional modifications may be made.

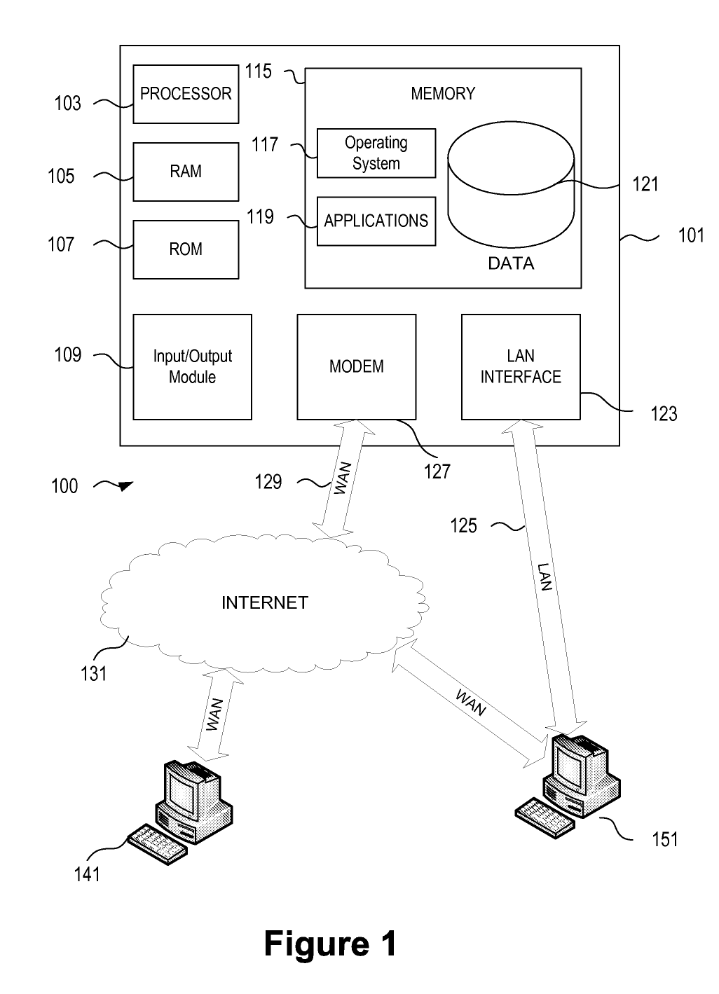

FIG. 1 illustrates a block diagram of a generic computing device 101 (e.g., a computer server) that may be used according to an illustrative embodiment of the disclosure. The computer server 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown). As described in detail below, the database 121 may provide centralized storage of characteristics associated with individuals, allowing interoperability between different elements of the business residing at different physical locations.

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP and the like is presumed.

Computing device 101 and/or terminals 141 or 151 may also be mobile terminals including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, mobile computing devices, e.g., smart phones, wearable computing devices, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

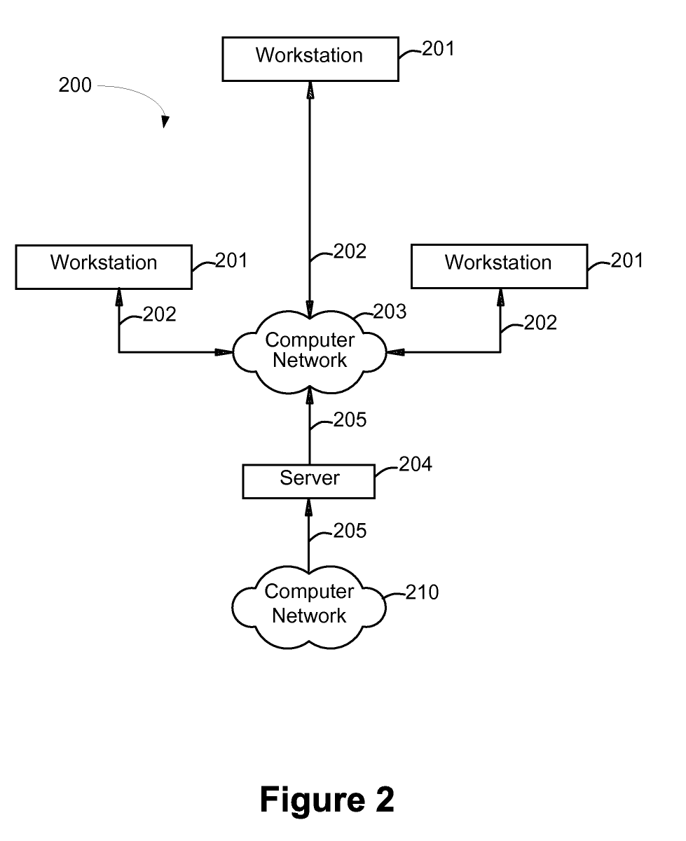

Referring to FIG. 2, an illustrative system 200 for implementing methods according to the present disclosure is shown. As illustrated, system 200 may include one or more workstations 201. Workstations 201 may be local or remote, and are connected by one or more communications links 202 to computer network 203 that is linked via communications links 205 to server 204. In system 200, server 204 may be any suitable server, processor, computer, or data processing device, or combination of the same.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

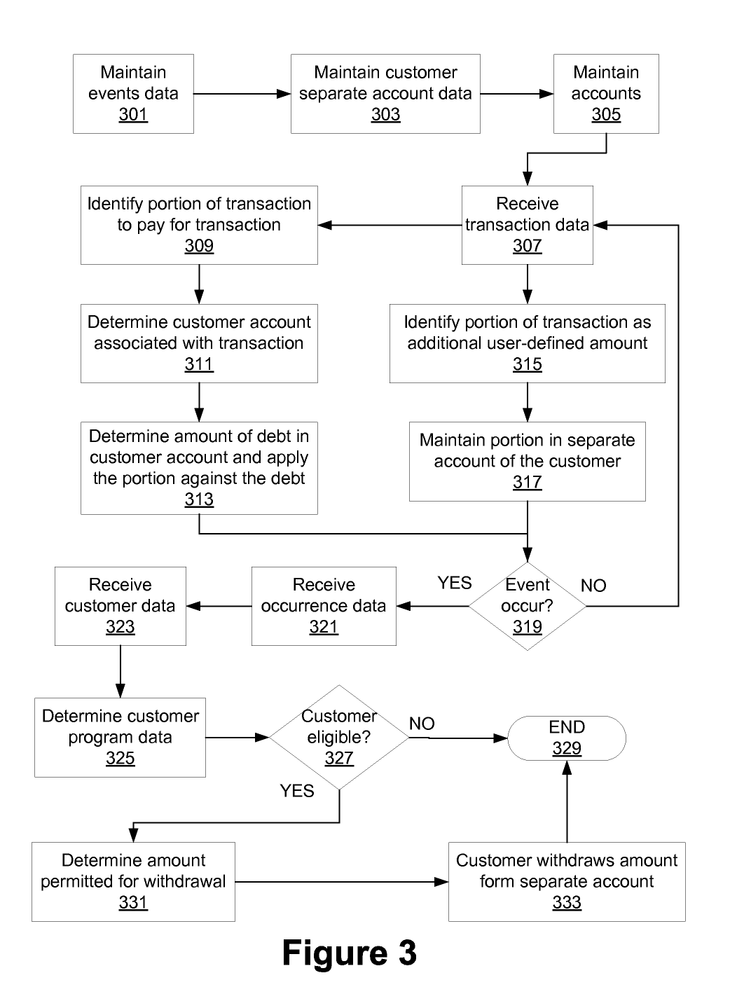

FIG. 3 is an example flow chart of an illustrative method for providing a transactional savings and/or investment service to a customer in accordance with at least one aspect of the present disclosure. As understood by those skilled in the art, the steps that follow in FIG. 3 may be implemented by one or more of the components in FIGS. 1 and 2 and/or other components, including other computing devices.

Aspects of the present disclosure describe a transactional savings and/or investment service or product that assists a customer and/or her family that has an account with an entity when a sudden loss of income and/or a special event occurs. The product or service may be optional and may be designed to provide a lump sum payment from an account associated with the customer with the entity.

For example, the product may be affiliated with a credit card account of the customer. In making payments on the credit card account, a customer may make a payment that includes the minimum required payment for the outstanding debt associated with the credit card account as well as a user-defined additional amount. The user-defined additional amount may be maintained in a separate account from the credit card account for use upon occurrence of a triggering event. The entity may choose to match funds deposited by the customer into the separate account. The matching may be a percentage of the monetary funds deposited by the customer and/or may be a separate predefined amount. Upon occurrence of one or more triggering events, monetary funds in the separate account may be may be made available to the customer in accordance with one or more aspects described herein. The product or service may be offered to customers for a nominal fee, such as a monthly fee that does not change. For each month of coverage of the event, the product or service may increase the matched amount deposited by the entity into the separate account of the customer.

A triggering event that initiates the permission to monetary funds in the separate account of the customer may be any of a number of predefined events. In addition, the amount of matching monetary funds, the calculation of matching monetary funds, and/or amount of permitted withdrawal of monetary funds may be any amount of matching monetary funds, any calculation of matching monetary funds, and/or any amount of permitted withdrawal and the illustrative examples described herein are not limiting. In one embodiment, triggering events may include involuntary unemployment of the customer or a spouse of the customer. In such an example, the product may offer permission to withdrawal all monetary funds in the separate account upon validating the involuntary employment status.

Other examples of triggering events may include a need for family leave, such as a customer that must tend to an ailing parent for an extended period of time, disability of the customer or spouse of the customer, a marriage of the customer, a divorce of the customer, a birth of a child by the customer, and an adoption of a child by the customer. Still other types of triggering events may include a retirement of the customer or spouse of the customer, entering into or graduating from a college or post graduate school by the customer or member of the customer's family, academic excellence by the customer or a member of the customer's family, and a hospitalization of the customer or member of the customer's family. As should be understood, these are but illustrative examples of triggering events and any of a number of other types of triggering events may be included within the product or service.

Still other examples of triggering events may include user definable triggering events to which an entity agrees. An entity associated with the accounts may offer customer the option to define specific triggering events. For example, a customer may desire to create a triggering event not specifically offered by the entity. Such a situation may be where a customer wants a triggering event to be a child getting into a certain university that has a high tuition. The customer may commence an arrangement with the entity to have such a triggering event be part of the service provided by the entity. The inclusion of such a user defined triggering event may be subject to approval and/or agreement by the entity, make include an additional fee, may include a combination of the two, and/or may include some other requirement. In still other examples, the triggering events may be a selectable set of triggering events that a customer may choose from for a service. For example, one level of service may be three user selected triggering events from the selectable set for a fee of $10 per month, a second level of service may be five user selected triggering events from the selectable set for a fee of $30 per month, and a third level of service may be ten user selected triggering events from the selectable set for a fee of $50 per month.

With respect to these triggering events, any number of different amounts permitted to be withdrawn may be implemented in accordance with one or more aspects of the present disclosure. For example, a triggering event that may be thought to have a more profound impact on the income of a customer may allow for more monetary funds in the separate account to be authorized for withdrawal. For example, if the triggering event is involuntary unemployment, the customer may be able to withdraw all monetary funds form the separate account. In the alternative, if the triggering event is the fact that the customer is moving, the amount may be limited to some amount less than the total amount in the separate account as such an event would likely have less of an impact on the financial life of the customer. However, as should be understood, any number of different amounts permitted to be withdrawn may be utilized for a triggering event. In addition, a type of triggering event may have different levels of permission for withdrawn. For example, the birth of a single child may have an amount permitted to be withdrawn set for $500, while the birth of twins or triplets may have an amount permitted to be withdrawn set for $2000 or $3000.

Still further with respect to the triggering events, any number of different amounts of matching monetary funds by an entity may be implemented in accordance with one or more aspects of the present disclosure. For example, a triggering event that may be thought to have a more profound impact on the income of a customer may have a greater matching of monetary funds by an entity. In such an example, the entity need not match any monetary funds in the separate account until a triggering event has occurred and been confirmed. For example, if the triggering event is a disability of the customer preventing the customer from working, the matching of monetary funds by the entity for the separate account of the customer may be 100%. In the alternative, if the triggering event is the fact that the customer is getting married, the matching of monetary funds by the entity for the separate account of the customer may be 10% as such an event would likely have less of an impact on the financial life of the customer. However, as should be understood, any number of different matching of monetary funds by an entity may be utilized for a triggering event.

In addition, a type of triggering event may have different calculation of matching monetary funds by an entity. Payment to a first type of account of a customer, such as a mortgage, may have a different calculation for the matching of monetary funds by an entity for the customer getting married, such as matching 3%, in comparison to a different type. For example, payment to a second type of account of the customer, such as a credit card account, may have a calculation for the matching of monetary funds by an entity of 1% for the same triggering event, the customer getting married.

In accordance with other aspects of the present disclosure, more than one triggering event may occur at the same time. For example, while planning to get married, a customer's child may become extremely ill requiring a threshold level of medical expenses for care. As such, the customer may trigger two separate events, a marriage event and a child illness event. In such a situation, the product or service may be configured to allow for a specific amount of withdrawal of monetary funds from the separate account of the customer for an event, such as $500, be implemented twice. Therefore, the specific amount of withdrawal from the separate account may be $500 for the marriage triggering event and $500 for the child illness triggering event. In still other examples, the product or service may be configured to permit withdrawal of monetary funds for one triggering event at a time. In yet other examples, the product or service may be configured to permit withdrawal of monetary funds for the triggering event of the plurality that is a greater amount authorized for withdrawal by the customer. For example, if one event would permit withdrawal of $500 while a second event would permit withdrawal of $1000, the system may be configured to permit withdrawal of $1000, the greater of the two permission amounts.

Similarly, aspects of the present disclosure may be configured to allow for a specific amount of matching of monetary funds to the separate account of the customer for an event, such as $500, be implemented twice. Therefore, the specific amount of matching monetary funds by an entity to the separate account may be $500 for a marriage triggering event and $500 for a child illness triggering event. In still other examples, the product or service may be configured to match monetary funds of an entity for one triggering event at a time. In yet other examples, the product or service may be configured to match monetary funds by an entity for the triggering event of the plurality that is a greater amount. For example, if one event would have the entity match 50% of the current amount in the separate account while a second event would have the entity match 25%, the system may be configured to have the entity match 50%, the greater of the two matching percentages.

As should be understood, the matching of monetary funds by an entity on a separate account of the customer may be configured never to exceed a threshold amount. As such, whether for a single matching amount and/or multiple events to cause multiple matching amounts, the total amount matched by an entity may never exceed a certain specified maximum amount. For example, if the product or service is associated with a mortgage payment on a home of a customer, the matching amount may be 10% of the total amount in the separate account deposited by the customer per triggering event with a maximum matching amount of $1000. There may be a threshold amount that the product or service may not exceed for matching purposes. In the above example, the threshold amount may be $1000. As such, the matching amount by an entity associated with the home mortgage payment may be 10% of the total amount in the separate account deposited by a customer based upon the occurrence of one or more triggering events but never more than $1000.

The product or service described herein is not a loan or line of credit or a reduction in an amount of debt. The customer still owes any debt on the account and is not offered additional credit associated with the account because of the service or product. During a benefit period, the customer is free to continue to incur debt associated with the account, such as in the case of a credit card.

Upon occurrence of an event, a customer may not want to implement the permission to access the monetary funds in the separate account. For example, the product or service described herein may be configured to allow for the access to monetary funds, including matched monetary funds, upon a single occurrence within a calendar year. The customer may know that she is moving to a new job in October. Although she may be having a baby in February, she may not want to access the monetary funds in the separate account. She may prefer to have the access to the monetary funds occur in October upon her move. As such, in accordance with one or more aspects described herein, a customer may override the implementation of permitted access to monetary funds in a separate account. In other examples, a customer may specify to the business offering the service or product when the customer would like to access the monetary funds. A customer may choose the period of time and/or the event in question for triggering the access to the monetary funds.

In yet other examples, a fee may be associated with the transactional savings as described herein. In signing up for the service or product, a customer may be provided options for different events triggering the access to monetary funds and/or different levels of matching by an entity. For example, a basic service may provide for matching of 1% by an entity upon triggering of one of three events if a customer deposits $10 a month in the separate account for the service. A second service may provide for matching of 4% by the entity upon triggering of one of five events if a customer deposits $30 a month in the separate account for the service. Any of a number of different fee structures for different types of events and/or different amounts of matching of monetary funds may be utilized in accordance with the description herein.

Aspects of the present disclosure may be implemented with respect to any of a number of financial products or services, including, but not limited to, a credit card, a home equity loan, an automobile or other vehicle, such as a motorcycle, a boat, or an all terrain vehicle, a payment plan, and a mortgage. In addition, aspects of the present disclosure may be included with other existing products or services of a business. With respect to paying any applicable service deposit cost for the service, a customer may utilize other products. A customer may be in a program where, for every credit card purchase, the amount billed to the credit card account of the customer may be the amount of the purchase rounded up to the next whole dollar. For example, a customer may charge a purchase to a credit card account for $25.19. In billing the customer for the purchase, the account of the customer may be billed $26.00 and the $0.81 difference may be applied against the deposit cost for the service of the transactional savings. As such, a customer may not readily pay the monthly deposit cost up front but instead pay the deposit cost over time in use of the credit card. The difference amount may be applied against a required deposit cost up to a certain amount, such as $10 a month. Other types of products or services offered by an entity may utilize one or more aspects of the present disclosure and the illustrative examples described herein are not limiting.

Returning to FIG. 3, the process starts and at step 301, event data representative of a plurality of triggering events associated with a transactional savings program of an entity may be maintained. In such an example, the event data may be stored within a memory/database, such as memory 115 and/or RAM 105 in FIG. 1. As described above, any number of different types of triggering events may be designated, such as the birth of a child, a sudden loss of employment, or an illness in the family. Proceeding to step 303, separate account data associated with the transactional savings program for a plurality of customers may be maintained. Again, in such an example, the separate account data may be stored within a memory/database, such as memory 115 and/or RAM 105 in FIG. 1. Separate account data may include the amount in a separate account, a default total amount of withdrawal permitted for different triggering events, data regarding the calculation for matching of monetary funds by the entity, and the amount of matching monetary funds by the entity.

Proceeding to step 305, a plurality of accounts associated with the plurality of customers of the entity may be maintained. In such an example, data of the accounts may be stored within a memory/database, such as memory 115 and/or RAM 105 in FIG. 1. In 307, transactional data associated with a transaction of a customer may be received. A transaction may be a payment by the customer on a credit card account the customer has with the entity, a mortgage loan payment the customer has with the entity, or any of a number of other payments the customer may make to the entity with respect to a debt the customer has with an account with the entity. For example, a transaction may be a payment made by a customer on a credit card account. Upon receipt of a monthly bill from the entity associated with the credit card account, the customer may make a payment against the debt of the credit card account.

In 309, a portion of the total amount of monetary funds being remitted by the customer as part of the transaction in 307 is identified as being associated with a payment to be made against a debt associated with an account of the customer with the entity. In the above example, the customer may remit a payment of $1000 for the transaction where the portion in 309 is $800, the minimum monthly payment required by the entity of the credit card account. As described more fully below, the remaining $200 may be a second portion identified as a user-defined amount for deposit in a separate account with the entity. Having identified the portion in 309, the process moves to 311 where a customer account associated with the transaction is determined. In the above example of a credit card payment, the determined account of the customer in 311 may be the credit card account of the customer with the entity.

In 313, the amount of debt in the determined customer account may be determined and the identified portion in 309 may be applied against the debt. Continuing with the credit card account example, in 313, the $800 identified as the portion in 307 may be applied against the debt that the customer has in the determined credit card account in 311. If the total amount of debt in the credit card account is $7000, the debt is reduced to $6200 after the $800 portion is applied against the $7000. Following 313, the process proceeds to 319.

Returning to 315, a portion of the total amount of monetary funds being remitted by the customer as part of the transaction in 307 is identified as an additional user-defined amount for deposit into a separate account of the customer with the entity. In 317, the identified amount in 315 may be maintained as a deposit in a separate account of the customer with the entity. In the above example, the customer may remit a payment of $1000 for the transaction where the portion in 309 is $800, the minimum monthly payment required by the entity of the credit card account. The remaining $200 may be a second portion identified as a user-defined amount for deposit in a separate account with the entity. The sum of the identified portion in 309 and identified portion in 315 may be the total amount of monetary funds remitted by a customer in 307. In alternative embodiments, a third portion of monetary funds may be identified and/or utilized for another purpose, such as for deposit into a savings account of the customer. The identified portion in 309 and the identified portion in 315 are different monetary funds of the total amount of monetary funds. As such, if the total amount remitted by a customer is $100 for payment of a transaction in 307, if the identified portion in 309 is $75, the identified portion in 315 may be any amount from $0 to $25 but not any of the identified $75 of the identified monetary funds for application against a debt in 313.

In 317, the separate account of the customer may be configured to prevent withdrawal of monetary funds by the customer without a penalty fee for withdrawal. The separate account may be configured to allow a customer to withdrawal in response to a triggering event in which a financial impact on the customer might be expected. Examples of such as more fully described herein include involuntary unemployment, disability, family legal expenditures, and other examples.

In step 319, the process waits for a triggering event to occur. Once a triggering event, such as disability of the customer, occurs the process proceeds to step 321. If not event occurs, the process may return to 307. In step 321, occurrence data representative of an occurrence of a triggering event associated with a transactional savings program of the entity may be received. The occurrence data may be a phone call from the customer, it may be an entry through a graphical user interface associated with a web site of the entity, such as via a mobile device or wearable computer, and it may be a facsimile or other written data as well. Moving to step 323, customer data representative of a customer associated with the occurrence data may be received. The customer may be one of the plurality of customers that has one or more accounts with the entity.

In step 325, customer program data associated with the particular customer identified from the customer data is determined. If the customer has recently utilized the program with another triggering event and a period of time since the last triggering event has not occurred, the customer program data may show that the customer is not eligible for another permission to withdrawal monetary funds from the separate account for at least two months. A determination then is made in step 327 as to whether the customer is eligible for withdrawal monetary funds from the separate account of the customer with the entity. Such a determination may be based upon a number of variables. In one example, the system may determine whether the customer even is enrolled in the transactional savings program at all. If not, the process may end at step 329. In another example, a customer may call a hotline to indicate that she has just recently birthed a child, but may fail to provide any type of proof, such as hospital or doctor papers, a birth certificate, and/or a social security card of the newly born child. In such an example, the customer may not be eligible to access the monetary funds in the separate account and may be outright denied.

The determination in step 327 also may be based upon whether proof exists to show that the triggering event has occurred. For example, the customer may be required to present some form of data representative of proof of the occurrence of the triggering event. In one example, a customer may have to provide a copy of a receipt from a state unemployment office showing filing of paperwork regarding an involuntary unemployment status. In another example, for a birth of a child of a marriage by the customer, the customer may be required to provide documentary proof of a birth certificate or marriage certificate, respectfully. As should be understood by those skilled in the art, any number of different types of certifying documents may be required and may be specified by an entity in advance.

If a customer is deemed eligible in step 327 and the proof has been validated by the system to allow the benefit to take effect, the process moves to step 331 where an amount of monetary funds permitted for withdrawal from the separate account of the customer may be determined. In the example of the credit card account above, the system may determine that the customer may withdrawal monetary funds up to the $200 identified in 315 and maintained in the separate account of the customer in 317. As should be understood, a customer may deposit amounts for different transactions and each such amount per transaction may be maintained in 317 for potential withdrawal in 331. As described herein, the amount determined in 331 may be based upon the triggering event where a first triggering event may allow for withdrawal of all monetary funds in the separate account while a second triggering event may allow for withdrawal of monetary funds up to 50%, or up to $500, or some other value. Different triggering events may permit different amounts for withdrawal and multiple events occurring at once and/or within a defined time period may permit only the largest amount or multiple amounts for withdrawal. Proceeding to 333, the customer may access the separate account to withdraw monetary funds up to the determined amount in 331 before the process ends.

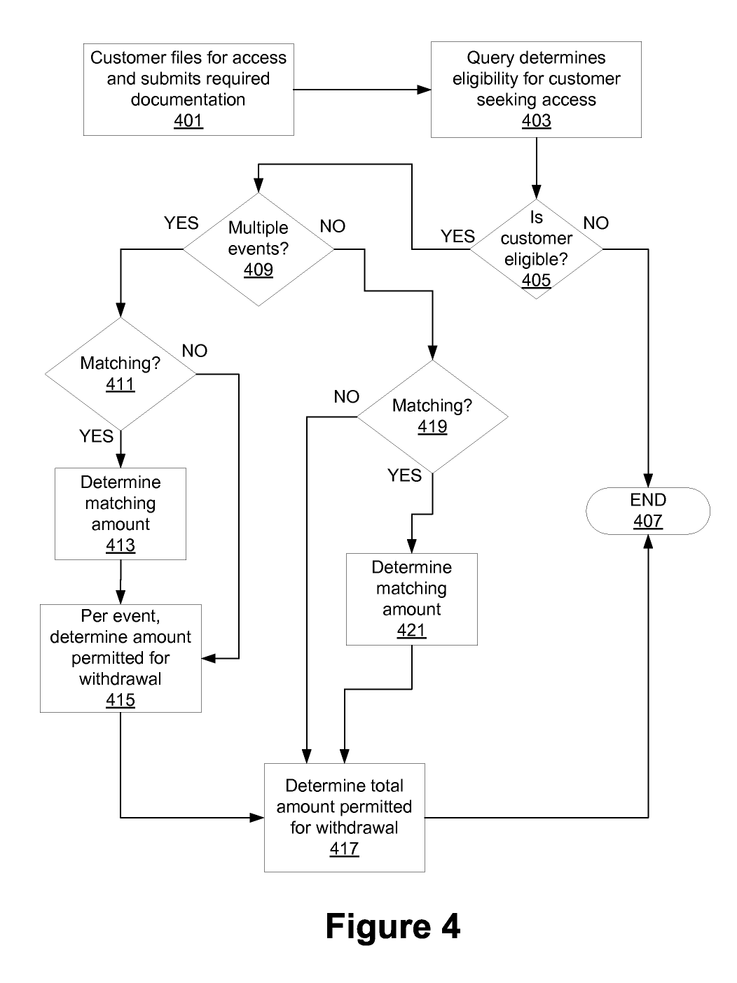

FIG. 4 is an example flow chart of an illustrative method for handling a request for withdrawing monetary funds from a separate account of a customer in accordance with at least one aspect of the present disclosure. The process starts at step 401 where a customer may file for access to monetary funds in a separate account of the customer with an entity due to a triggering event and may submit the required documentation and/or other information/data for proof of the occurrence of the triggering event. As previously described, in one example, for the adoption of a child, the customer may be required to submit a copy of the birth certificate and/or adoption documents.

In step 403, a query component of the system may determine the eligibility for the customer that is seeking access to the monetary funds in the separate account. Proceeding to step 405, a determination is made as to whether the customer is eligible for access to the monetary funds in the separate account. If the customer is not currently eligible, the process proceeds to step 407 where the process may end. If the customer is eligible in step 405, the process moves to step 409.

In step 409, a determination may be made as to whether multiple events have occurred, whether at the same time or within a specified period of time. Such an example may be a situation where a two triggering events for the customer have occurred. In that case, the customer may be eligible to have a multiple or different amounts permitted for withdrawal from the separate account of the customer. One example may be a case where a customer is moving and having a baby. The two triggering events may occur within the window period of time of the system, such as two months, for the system to treat the occurrence of the two events as multiple events in 409. If multiple triggering events are determined in 409, the process moves to 411 where another determination is made as to whether monetary funds in the separate account of the customer will be matched by some amount by the entity maintaining the account of the customer. The matching amount may be based upon any of a number of manners for calculating the amount. For example, the amount of the matching monetary funds may be a percentage of the current amount in the separate account of a customer. As such, if the matching amount is 2%, then a customer with a separate account balance of $1000 would receive $20 in matching monetary funds, while a customer with a separate account balance of $500 would receive $10 in matching monetary funds from the entity.

Other examples include matching based upon a minimum amount of monetary funds within the separate account, such as matching $50 for every $1000 in the separate account. Still other examples include matching based upon the type of triggering event. One type may warrant a matching amount by the entity of 2% while another triggering event may warrant matching of monetary funds by the entity of 5%. The examples described herein are merely illustrative of examples that may occur.

If no matching of monetary funds by an entity occurs in 411, the process proceeds to 415; else, the process proceeds to 413. In 413, the matching amount of monetary funds by the entity may be determined. As described herein, any of a number of calculations for matching of monetary funds by the entity may be implemented, including based upon the triggering event, based upon one or more threshold balance amounts in the separate account of the customer, based upon the last time the customer withdrew monetary funds form the separate account, based upon how long the separate account has been open, and/or based upon other criteria.

In 415, the amount of monetary funds permitted to be withdrawn from the account of the customer may be determined for each triggering event. Because the triggering events may warrant different amounts permitted to be withdrawn from the account, different amounts per triggering event may be determined in 415. If the process proceeds from 413, the determinations in 415 may be based upon the matching amounts determined in 413 as well. Following 415, the process moves to 417 before the process ends.

In 417, the total amount permitted to be withdrawn from the separate account by the customer may be determined. In the example of multiple triggering events, the total amount determined in 417 may be based upon the largest amount permitted for one triggering event of the multiple triggering events. As such, if a disability triggering event warrants permitting the customer to withdraw up to 75% monetary funds while a marriage triggering event warrants permitting the customer to withdraw up to 50% of the current balance of the monetary funds from the separate account, the determination in 417 may be to permit withdrawal of up to 75% of the monetary funds from the separate account since the disability triggering event permits a greater amount to be withdrawn. In yet another example, if an adoption triggering event warrants permitting the customer to withdraw up to 50% monetary funds and a child graduation triggering event warrants permitting the customer to withdraw up to 35% of the current balance of the monetary funds from the separate account, the determination in 417 may be to permit withdrawal of up to 85% of the monetary funds from the separate account; the sum permitted amount for the adoption triggering event and the child graduation event.

Returning to 409, the process moves to 419 where another determination is made as to whether monetary funds in the separate account of the customer will be matched by some amount by the entity maintaining the account of the customer. The matching amount may be based upon any of a number of manners for calculating the amount as described herein. If no matching of monetary funds by an entity occurs in 419, the process proceeds to 417; else, the process proceeds to 421. In 421, the matching amount of monetary funds by the entity may be determined. As described herein, any of a number of calculations for matching of monetary funds by the entity may be implemented. Following 421, the process moves to 417 before the process ends.

Other illustrative implementations of aspects of the present disclosure include a group of individuals in the capacity of a customer. First and second portions of a total amount associated with a transaction may be identified. The first portion and the second portion may be different monetary funds of the total amount of monetary funds. A first account may be for a group of individuals. The first account may be associated with an entity, may be determined, and an amount of debt of monetary funds of the first account may be determined. The first portion of the total amount of monetary funds may be applied against the amount of debt of the first account, and the second portion may be maintained in a second account of the customer. Occurrence data representative of an occurrence of a triggering event associated with a transactional savings program of the entity may be received, and an amount of the second account to permit access to by one or more members of the group of individuals may be determined based upon the occurrence data.

Examples of a group of individuals utilizing one or more aspects of the present disclosure described herein may include a family, such as a family of five, two parents and two children, along with a grandparent. One or more triggering events may be associated with one or more of the individuals in the group and the payout amounts from the occurrence of the triggering event may be different for different individuals in the group. For example, a triggering event for finding new employment by one member of the group may have different payouts and/or payouts to different individuals of the group in comparison to a second member of the group finding new employment.

Still other examples of a group of individuals utilizing one or more aspects of the present disclosure described herein may include a small business. The triggering events for the group of individuals in the small business may be correlated to business related triggering events and not events specific to the individuals of the group. For example, the triggering events may include dissolution of the small business, flooding of an office of the small business, and vehicle damage for equipment of the small business. Upon occurrence of a triggering event associated with the small business, individuals of the group of the small business may be allowed to withdraw monetary funds from a separate account and/or a representative of the small business may be allowed to withdraw monetary funds form the separate account.

Yet other examples of a group of individuals utilizing one or more aspects of the present disclosure described herein may include friends utilizing an online social network. The online social network may have an agreement with a financial entity for providing a service and/or product to participating users of the social network in accordance with one or more aspects described herein. A group of individuals, such as friends, that utilize the social network may utilize one or more aspects as described in the present disclosure that are offered through or by the social network. Any of a number of other examples of a group of individuals utilizing one or more aspects of the present disclosure described herein may be utilized.

The methods and features recited herein further may be implemented through any number of non-transitory computer readable media that are able to store computer readable instructions. Examples of non-transitory computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present disclosure. The description is thus to be regarded as illustrative instead of restrictive on the present disclosure.

1. A method comprising:
identifying a first portion and a second portion of a total amount of monetary funds associated with a transaction, the first portion being a minimum amount of monetary funds for the transaction and the second portion being a user defined amount of the monetary funds, the first portion and the second portion being different monetary funds of the total amount of monetary funds;
determining a first account of a customer associated with an entity;
determining an amount of debt of monetary funds of the first account;
applying the first portion of the total amount of monetary funds against the amount of debt of the first account;
maintaining the second portion in a second account of the customer;
receiving occurrence data representative of an occurrence of a triggering event associated with a transactional savings program of the entity; and
determining an amount of the second account to permit access to by the customer based upon the occurrence data.

2. The method of claim 1, wherein the sum of the first portion and the second portion equals the total amount of monetary funds.

3. The method of claim 1, further comprising receiving customer data representative of the customer associated with the occurrence data, the customer data including an identification of the second account of the customer with the entity.

4. The method of claim 1, wherein determining the amount of the second account to permit access to by the customer includes:
receiving data representative of proof of the occurrence of the triggering event; and
validating the received data representative of proof.

5. The method of claim 1, further comprising:
maintaining event data representative of a plurality of triggering events associated with the transactional savings program of the entity; and
for each triggering event, maintaining data representative of the amount of the second account to permit access to by the customer.

6. The method of claim 5, wherein the amount of the second account to permit access to by the customer is the total amount in the second account.

7. The method of claim 5, wherein the triggering event is involuntary unemployment of the customer.

8. The method of claim 1, wherein the user defined amount of the monetary funds is a percentage of the first portion.

9. The method of claim 1, wherein the first account of the customer is a mortgage loan and the second account of the customer is a savings account.

10. The method of claim 1, further comprising:
receiving second occurrence data representative of an occurrence of a second triggering event associated with the transactional savings program of the entity;
receiving customer data representative of the customer associated with the second occurrence data,
wherein the determining the amount of the second account to permit access to by the customer is based upon the second occurrence data.

11. The method of claim 1, further comprising:
determining a matching amount of monetary funds as a determined percentage of the second portion of the total amount of monetary funds; and
maintaining the matching amount in the second account of the customer.

12. The method of claim 11, wherein the determining the matching amount of monetary funds as the determined percentage is based upon a threshold amount of monetary funds in the second account.

13. The method of claim 11, wherein the determining the matching amount of monetary funds as the determined percentage is based upon a threshold time period the customer has been enrolled in the transactional savings program of the entity.

14. The method of claim 1, wherein the customer is a group of individuals.

15. One or more non-transitory computer readable media storing computer executable instructions that, when executed by at least one processor, cause the at least one processor to perform a method comprising:
identifying a first portion and a second portion of a total amount of monetary funds associated with a transaction, the first portion being a minimum amount of monetary funds for the transaction and the second portion being a user defined amount of the monetary funds, the first portion and the second portion being different monetary funds of the total amount of monetary funds;
determining a first account of a customer associated with an entity;
determining an amount of debt of monetary funds of the first account;
applying the first portion of the total amount of monetary funds against the amount of debt of the first account;
maintaining the second portion in a second account of the customer;
receiving occurrence data representative of an occurrence of a triggering event associated with a transactional savings program of the entity; and
determining an amount of the second account to permit access to by the customer based upon the occurrence data.

16. The one or more non-transitory computer readable media of claim 15, the instructions further causing the at least one processor to perform a method of receiving customer data representative of the customer associated with the occurrence data, the customer data including an identification of the second account of the customer with the entity.

17. The one or more non-transitory computer readable media of claim 15, wherein determining the amount of the second account to permit access to by the customer includes:
receiving data representative of proof of the occurrence of the triggering event; and
validating the received data representative of proof.

18. The one or more non-transitory computer readable media of claim 15, the instructions further causing the at least one processor to perform a method of:
maintaining event data representative of a plurality of triggering events associated with the transactional savings program of the entity; and
for each triggering event, maintaining data representative of the amount of the second account to permit access to by the customer.

19. The one or more non-transitory computer readable media of claim 15, the instructions further causing the at least one processor to perform a method of:
determining a matching amount of monetary funds as a determined percentage of the second portion of the total amount of monetary funds; and
maintaining the matching amount in the second account of the customer.

20. A system comprising:
at least one database configured to maintain a plurality of accounts associated with a plurality of customers of an entity; and
at least one computing device, operatively connected to the at least one database, configured to:
identify a first portion and a second portion of a total amount of monetary funds associated with a transaction, the first portion being a minimum amount of monetary funds for the transaction and the second portion being a user defined amount of the monetary funds, the first portion and the second portion being different monetary funds of the total amount of monetary funds;
determine a first account of a customer associated with an entity;
determine an amount of debt of monetary funds of the first account;
apply the first portion of the total amount of monetary funds against the amount of debt of the first account;
maintain the second portion in a second account of the customer;
receive occurrence data representative of an occurrence of a triggering event associated with a transactional savings program of the entity; and
determine an amount of the second account to permit access to by the customer based upon the occurrence data.

21. The system of claim 20, the at least one computing device further configured to:
maintain event data representative of a plurality of triggering events associated with the transactional savings program of the entity; and
for each triggering event, maintain data representative of the amount of the second account to permit access to by the customer.

22. The system of claim 20, the at least one computing device further configured to:
determine a matching amount of monetary funds as a determined percentage of the second portion of the total amount of monetary funds; and
maintain the matching amount in the second account of the customer.

23. The system of claim 20, wherein the user defined amount of the monetary funds is a percentage of the first portion.
